(19) United States
(12) Patent Application Publication
(10) Pub. No.: US 2024/0360025 A1
(43) Pub. Date: Oct. 31, 2024

(54) METHOD OF MANUFACTURING A POROUS GLASS BODY TO LOWER ATTENUATION OF OPTICAL FIBER MADE THEREFROM

(71) Applicant: CORNING INCORPORATED, CORNING, NY (US)

(72) Inventors: Steven Treavis Arndt, Mint Hill, NC (US); Ilia Andreyevich Nikulin, Wilmington, NC (US); Nikolay Anatolyevich Panin, Wilmington, NC (US); Sergey Nikolaevich Shubin, Espoo (FI)

(21) Appl. No.: 18/638,912

(22) Filed: Apr. 18, 2024

Related U.S. Application Data
(60) Provisional application No. 63/462,714, filed on Apr. 28, 2023.

(51) Int. Cl. C03B 37/018; C03B 37/027

(52) U.S. Cl. CPC C03B 37/01853; C03B 37/027

(57) ABSTRACT

A method of manufacturing including: with a porous glass body having a surface and a density at the surface having been loaded into a furnace with heating elements disposed along a length of the porous glass body, a first heat treatment step comprising activating the heating elements until the porous glass body at an inner surface of the porous glass body facing a centerline of the porous glass body has a first temperature that is greater than or equal to 1250° C. for a first period of time greater than or equal to 1 hour; wherein, as a result of the first heat treatment step, the density of the porous glass body at the surface increases but is less than 85% of a closed pore density of a sintered glass preform made from the porous glass body.

This application claims the benefit of priority under 35 U.S.C. § 120 of U.S. Provisional Application Ser. No. 63/462,714 filed on Apr. 28, 2023, the content of which is relied upon and incorporated herein by reference in its entirety.

### FIELD OF THE DISCLOSURE

This disclosure pertains to the manufacture of optical fiber and, more specifically, optical fiber with improved attenuation and defect density.

### BACKGROUND

Optical fiber is sometimes used as a medium to transmit light, often with data embedded therein. The optical fiber sometimes includes a core and a cladding surrounding the core. The core sometimes has a higher index of refraction than the cladding. In such instances, the light transmits through the core, without substantially escaping from the core into the cladding, due to total internal reflection within the core. After transmitting through the optical fiber, the light is converted into an electrical signal with the data embedded therein.

In the manufacture of optical fiber, an initial step is sometimes the generation of a porous glass body (sometimes called a porous preform). The porous glass body is a cylindrical rod of glass with a relatively large circumference compared to the optical fiber eventually made from the porous glass body. The porous glass body can be made through a chemical vapor deposition process that deposits layers of porous soot upon a rotating rod within a furnace.

The porous glass body is sometimes then subjected to a heat treatment referred to as consolidation or sintering. In some cases, the porous glass body is hung vertically within a furnace and guided down through a narrow hot zone where only a portion of a length of the porous glass body is sintered at any given point in time. That portion of the length of the porous glass body subjected to localized heating is sometimes referred to as an axial sintering front. At the axial sintering front, pores within the preform close and gas within the pores escapes upward in the still porous portions of the porous glass body above the axial sintering front. Contaminants in the gas that would otherwise degrade the performance of the resulting optical fiber escape as well.

There could be motivations to use a porous glass body with a length that is too long for furnaces designed to locally heat the porous glass body in a manner that generates the axial sintering front. Instead, a furnace could be utilized that simultaneously heats the entire length of the porous glass body.

However, there is a problem in that optical fiber eventually made from the porous glass body of relatively long length and subjected to heat-treatment simultaneously along its entire length exhibits suboptimal attenuation and defect density. Attenuation means the loss of signal strength as light travels through the optical fiber. Defect density refers to the number of holes and diameter upsets within the optical fiber per unit length of the optical fiber (e.g., defects/kkm).

### SUMMARY

The present disclosure addresses that problem with a heat treatment step that includes a prolonged holding time at a temperature high enough to cause diffusion of metals, metal oxides, and/or metal halides out of the porous glass body but low enough to prevent substantial closing of the pores of the porous glass body at the surface of the porous glass body. The heat treatment step can occur after a preheating heat treatment step that occurs at a lower temperature and which includes the introduction of halogen gas or hydrogen halide gas to facilitate conversion of the metal and metal oxides within the porous glass body to metal halides, which have a lower boiling point than the metal and metal oxides and thus more easily diffuse out of the porous glass body. After the heat treatment step, the porous glass body, now freer of metals, metal oxides, and metal halides, is subjected to a second heat treatment step that sinters the porous glass body into a sintered preform. After subsequent steps to form an optical fiber preform, optical fiber is drawn therefrom. The optical fiber exhibits improved attenuation and less defect density compared to optical fiber drawn from an optical fiber preform not preceded by the heat treatment step heretofore described.

According to a first aspect of the present disclosure, a method of manufacturing comprises: with a porous glass body having a surface and a density at the surface having been loaded into a furnace with heating elements, a first heat treatment step comprising activating the heating elements until the porous glass body at an inner surface of the porous glass body facing a centerline of the porous glass body has a first temperature that is greater than or equal to 1250° C. for a first period of time greater than or equal to 1 hour; wherein, as a result of the first heat treatment step, the density of the porous glass body at the surface increases but is less than 85% of a closed pore density of a sintered glass preform made from the porous glass body.

According to a second aspect of the present disclosure, the method of the first aspect is presented, wherein a length of the porous glass body, before the first heat treatment step occurs, is greater than or equal to 1 meter.

According to a third aspect of the present disclosure, the method of any one of the first through second aspects is presented, wherein the first temperature is within a range of from 1250° C. to 1400° C.

According to a fourth aspect of the present disclosure, the method of any one of the first through third aspects is presented, wherein the first temperature is within a range of from 1250° C. to 1350° C.

According to a fifth aspect of the present disclosure, the method of any one of the first through fourth aspects is presented, wherein the first period of time is greater than or equal to 4 hours.

According to a sixth aspect of the present disclosure, the method of any one of the first through fifth aspects is presented, wherein the first period of time is within a range of from 4 hours to 9 hours.

According to a seventh aspect of the present disclosure, the method of any one of the first through sixth aspects is presented, wherein during the first heat treatment step, an environment to which the porous glass body is subjected within the furnace comprises a cleaning gas comprising a halogen gas, a hydrogen halide gas, or carbon monoxide.

According to an eighth aspect of the present disclosure, the method of the seventh aspect is presented, wherein the cleaning gas comprises chlorine gas (Cl₂).

According to a ninth aspect of the present disclosure, the method of any one of the first through eighth aspects further comprises: a core vapor deposition step of vapor depositing core glass material upon a substrate to form the porous glass body.

According to a tenth aspect of the present disclosure the method of the ninth aspect further comprises a second core vapor deposition step of vapor depositing second core glass material over the core glass material deposited during the core vapor deposition step to further form the porous glass body, wherein, the second core glass material and the cover glass material are different.

According to a eleventh aspect of the present disclosure, the method of any one of the first through tenth aspects further comprises: a preheating heat treatment step, occurring before the first heat treatment step, comprising activating the heating elements of the furnace so that the environment to which the porous glass body is subjected has a preheating temperature that is greater than or equal to 800° C. but below the first temperature for a preheating period of time.

According to a twelfth aspect of the present disclosure, the method of the eleventh aspect is presented, wherein during the preheating heat treatment step, the environment to which the porous glass body is subjected comprises a halogen gas, a hydrogen halide gas, or carbon monoxide.

According to a thirteenth aspect of the present disclosure, the method of any one of the eleventh through twelfth aspects is presented, wherein the preheating temperature is within a range of from 800° C. to 1200° C.

According to a fourteenth aspect of the present disclosure, the method of any one of the eleventh through twelfth aspects is presented, wherein the preheating temperature is within a range of from 1050° C. to 1200° C.

According to a fifteenth aspect of the present disclosure, the method of any one of the eleventh through fourteenth aspects is presented, wherein the preheating period of time is greater than or equal to 2 hours.

According to a sixteenth aspect of the present disclosure, the method of any one of the eleventh through fourteenth aspects is presented, wherein the preheating period of time is within a range of from 2 hours to 6 hours.

According to a seventeenth aspect of the present disclosure, the method of any one of the first through sixteenth aspects further comprises a second heat treatment step comprising activating the heating elements of the furnace so that the environment to which the porous glass body is subjected has a second temperature that is greater than or equal to 1400° C. thus causing the porous glass body to densify.

According to an eighteenth aspect of the present disclosure, the method of the seventeenth aspect is presented, wherein during the second heat treatment step, the porous glass body densifies primarily radially inward toward a centerline of the porous glass body.

According to a nineteenth aspect of the present disclosure, the method of any one of the seventeenth through eighteenth aspects is presented, wherein the second temperature is within a range of from 1400° C. to 1600° C.

According to a twentieth aspect of the present disclosure, the method of any one of the seventeenth through eighteenth aspects is presented, wherein the second temperature is within a range of from 1400° C. to 1500° C.

According to a twenty-first aspect of the present disclosure, the method of any one of the seventeenth through twentieth aspects is presented, wherein the second heat treatment step occurs until the density at the surface of the porous glass body is greater than 99% of the closed pore density, thus transforming the porous glass body into a sintered glass preform.

According to a twenty-second aspect of the present disclosure, the method of the twenty-first aspect further comprises a redraw step comprising redrawing the sintered glass preform into a core cane.

According to a twenty-third aspect of the present disclosure, the method of the twenty-second aspect further comprises (a) an outer cladding step comprising forming a porous outer cladding layer over the core cane; and (b) a cladding sintering step comprising sintering the porous outer cladding layer thus forming an optical fiber preform.

According to a twenty-fourth aspect of the present disclosure, the method of the twenty-third aspect further comprises an optical fiber draw step comprising drawing an optical fiber from the optical fiber preform.

According to a twenty-fifth aspect of the present disclosure, a core cane made from the porous glass body made according to the method of any one of the first through twenty-second aspects.

According to a twenty-sixth aspect of the present disclosure, an optical fiber preform made from the porous glass body made according to the method of any one of the first through twenty-third aspects.

According to a twenty-seventh aspect of the present disclosure, an optical fiber made from the optical fiber preform of the twenty-sixth aspect.

According to a twenty-eighth aspect of the present disclosure, the optical fiber of the twenty-seventh aspect is presented, wherein (i) the optical fiber exhibits an attenuation of electromagnetic radiation having a wavelength of 1310 nm of less than or equal to 0.324 dB/km as measured with an optical time-domain reflectometer, and (ii) the optical fiber exhibits an attenuation of electromagnetic radiation having a wavelength of 1550 nm of less than or equal 0.186 dB/km as measured with an optical time-domain reflectometer.

### BRIEF DESCRIPTION OF THE DRAWINGS

In the Drawings:

FIG. 1 is a flow chart of a method of manufacturing an optical fiber, illustrating a first heat treatment step that subjects a porous glass body to a first temperature sufficient to remove metals, metal oxides, and metal halides from the porous glass body without completely sintering the surface of the porous glass body;

FIG. 2 is a schematic illustration of the first heat treatment step of the method of FIG. 1, illustrating the porous glass body in a furnace;

FIG. 3 is a schematic illustration of a core vapor deposition step of the method of FIG. 1, illustrating core glass material depositing upon a substrate to form the porous glass body that is eventually subjected to the first heat treatment step;

FIG. 4 is a schematic illustration of a second heat treatment step of the method of FIG. 1 condensing the porous glass body into a sintered glass preform;

FIG. 5 is a schematic illustration of a redraw step of the method of FIG. 1, illustrating core canes being drawn from the sintered glass preform of FIG. 4;

FIG. 6 is a schematic illustration of an outer cladding vapor deposition step of the method of FIG. 1, illustrating a porous outer cladding layer being formed upon one of the core canes of FIG. 4 via a chemical vapor deposition process;

FIG. 7 is a cross-sectional view of an optical fiber preform formed after a cladding sintering step of the method of FIG. 1 that sinters the porous outer cladding layer of FIG. 6;

FIG. 8 is a schematic illustration of optical fiber being drawn from the optical fiber preform of FIG. 7;

FIG. 9, pertaining to Example 1 and Comparative Example 2, is a graph plotting relative refractive index of the optical fiber at the core portion as a function of distance from the centerline of the optical fiber, illustrating that the relative refractive index gradually changes due to the management of the flow rate of the doping constituent source material (here, GeCl₄) during the core vapor deposition step;

FIG. 10, pertaining to Example 1 and Comparative Example 2, is a graph that plots the temperature of the environment within the furnace of FIG. 2 during a preheating heat treatment step of the method of FIG. 1, the first heat treatment step (for Example 1), and a second heat treatment step of the method of FIG. 1 that sinters the porous glass body;

FIG. 11 plots defect density present in optical fibers made according to Example 1 (including the first heat treatment step of the method of FIG. 1) and Comparative Example 2 (not including the first heat treatment step), illustrating that the optical fibers made according to Example 1 have much less defect density than those made according to Example 2; and

FIG. 12 plots attenuation that optical fibers made according to Example 1 and Comparative Example 2 exhibit for electromagnetic radiation having a wavelength of 1310 nm (top graph) and having a wavelength of 1550 nm (bottom graph), illustrating that optical fibers made according to Example 1 exhibit substantially less attenuation than optical fibers made according to Comparative Example 2.

### DETAILED DESCRIPTION

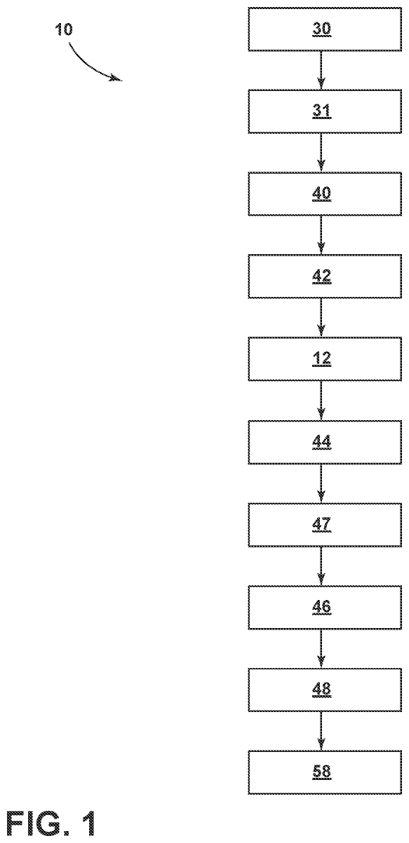

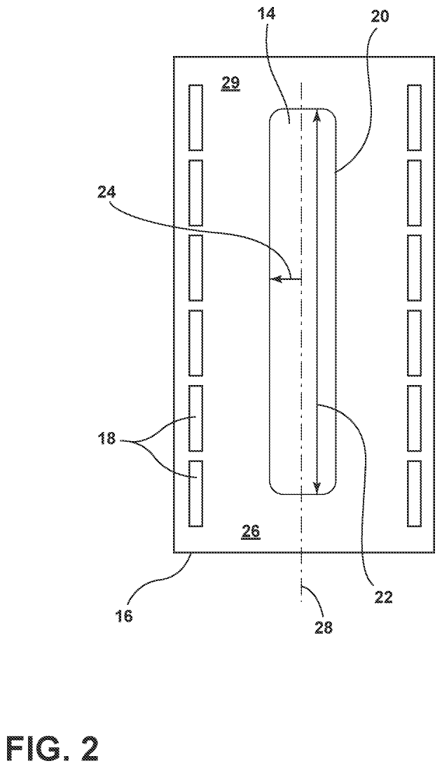

Referring now to FIGS. 1-4, a method 10 of manufacturing is herein described. The method 10 includes a first heat treatment step 12. The first heat treatment step 12 is performed on a porous glass body 14 that has been loaded into a furnace 16 with heating elements 18. In some instances, the furnace 16 is made of or includes material that can withstand the temperatures described herein for the first heat treatment step 12, such as graphite or ceramic. The heating elements 18 can be any kind of heating element 18 capable of achieving the temperatures described herein for the first heat treatment step 12. For example, the heating elements 18 can generate heat via induction or resistance.

The porous glass body 14 includes a surface 20, a length 22, and a radius 24. The surface 20 is exposed to an environment 26 within the furnace 16. The length 22 of the porous glass body 14 is as measured parallel to a centerline 28 of the porous glass body 14. In embodiments, the length 22 of the porous glass body 14 is greater than or equal to 1 meter. In embodiments, the porous glass body 14 is a cylinder or a hollow cylinder, and the centerline 28 is the axis of the cylinder or the hollow cylinder (e.g., the core axis). The heating elements 18 of the furnace 16 can be disposed along the length 22 of the porous glass body 14. In other words, the heating elements 18 are of the furnace 16 but can be positioned to direct heat to the porous glass body 14 along the length 22 of the porous glass body 14. The radius 24 is the distance between the surface 20 and the centerline 28 of the porous glass body 14.

The porous glass body 14 has a density at the surface 20. Understanding that density is the mass per unit volume, and that the surface 20 of the porous glass body 14 is not a volume, “density at the surface” means the average density of a volume of the porous glass body 14 (i) bound at least in part by the surface 20 and (ii) that extends from the surface 20 into the porous glass body 14 a distance of 5 percent of the radius 24 of the porous glass body 14.

The first heat treatment step 12 includes activating the heating elements 18 until the porous glass body 14 at an inner surface 35 of the porous glass body 14 facing the centerline 28 has a first temperature that is greater than or equal to 1250° C. for a first period of time greater than or equal to 1 hour. The temperature at the inner surface 35 can be monitored with a temperature sensor, such as a thermocouple in contact with the inner surface 35 of the porous glass body 14.

As a result of the first heat treatment step 12, the density of the porous glass body 14 at the surface 20 increases. During the first heat treatment step 12, the first temperature is sufficient to cause the porous glass body 14 to change chemically and physically. The chemical changes include (i) removing a metal, metal oxide, or metal halide from the porous glass body 14, (ii) changing an oxidation state of a metal or metal oxide within the first porous glass body 14, or (iii) a combination of (i) and (ii). The presence of one or more metals, metal oxides, and metal halides within the porous glass body 14 are thought to contribute to the suboptimal attenuation of optical fibers made from the porous glass body 14. When the porous glass body 14 has the first temperature that is greater than or equal to 1250° C., the one or more metals, metal oxides, and metal halides can vaporize and escape through the pores of the porous glass body 14. Accordingly, optical fiber eventually made from the porous glass body 14 has less attenuation compared to an optical fiber derived from a porous glass body 14 that did not undergo the first heat treatment step 12. In short, the first heat treatment step 12 “cleans” the porous glass body 14, which increases the purity of the optical fiber derived from the porous glass body 14.

As mentioned above, the porous glass body 14 additionally undergoes physical changes during the first heat treatment step 12. Such physical changes include shrinking and closing of pores within the porous glass body 14 as well as densification of the porous glass body 14 including at the surface 20 thereof. However, during the first heat treatment step 12, the shrinking and closing is not complete. Rather, as a result of the first heat treatment step 12, although the density at the surface 20 may increase, the density at the surface 20 is less than 85% of a closed pore density of a sintered glass preform made from the porous glass body 14. The closed pore density is the density of the sintered glass preform that has no open or interconnected pores. One of the purposes of sintering the porous glass body 14, which may occur after the first heat treatment step 12 (and is discussed below) is to minimize porosity, preferably to the point of no open or interconnected pores. Sintering accordingly results in a closed pore density, which, in the instance of pure silica, would be 2.2 g/cm³.

The first heat treatment step 12 is thus a balance of competing factors. On one hand, the first temperature ought to be high enough to permit vaporization of metal, metal oxides, and metal halides, and to change the oxidation state of the metals and metal oxides, within the porous glass body 14. Similarly, the first period of time ought to be long enough to permit such chemical changes to occur to a sufficient degree to result in lower attenuation. The first temperature being greater than or equal to 1250° C., and the first period of time being greater than or equal to 1 hour, are thought to satisfy those goals.

On the other hand, the combination of the first temperature and the first period of time ought not to be such that the density at the surface 20 approaches the closed pore density. In short, it is undesirable, as a result of the first heat treatment step 12, for the pores at and near the surface 20 of the porous glass body 14 to narrow too much or to close. Such a result would hinder vaporization of metal, metal oxides, and metal halides from the porous glass body 14 and reduce the benefit of the first heat treatment step 12.

In embodiments, the first temperature is within a range of from 1250° C. to 1400° C. In embodiments, the first temperature is within a range of from 1250° C. to 1350° C. In embodiments, the first temperature is 1250° C., greater than 1250° C., 1260° C., 1270° C., 1280° C., 1290° C., 1300° C., 1310° C., 1320° C., 1330° C., 1340° C., 1350° C., 1360° C., 1370° C., 1380° C., 1390° C., or 1400° C., or within any range bound by any two of those values (e.g., from 1270° C. to 1320° C., from 1280° C. to 1370° C., and so on).

In embodiments, the first period of time is greater than or equal to 4 hours. In embodiments, the first period of time is within a range of from 4 hours to 9 hours. In embodiments, the first period of time is 1 hour, greater than 1 hour, 2 hours, 3 hours, 4 hours, 5 hours, 6 hours, 7 hours, 8 hours, or 9 hours, or within any range bound by any two of those values (e.g., from 1 hour to 2 hours, from 3 hours to 8 hours, and so on). Further, it is envisioned that any of the first temperatures can be matched with any of the first periods of time, including ranges thereof. For example, the first period of time can be 6 hours and the first temperature can be 1310° C., and so on.

In embodiments, during the first heat treatment step 12, the environment 26 to which the porous glass body 14 is subjected within the furnace 16 includes a cleaning gas 29. In embodiments, the cleaning gas 29 includes one or more of a halogen gas, a hydrogen halide gas, and carbon monoxide (CO). Examples of a halogen gas and a hydrogen halide gas include chlorine gas (Cl₂) and hydrogen chloride gas (HCl), respectively. In embodiments, the hydrogen gas or hydrogen halide gas of the cleaning gas 29 has a partial pressure that is greater than or equal to 7 torr (˜933 Pa). In other embodiments, the carbon monoxide of the cleaning gas 29 has a partial pressure that is within a range of from 1 torr (˜133 Pa) to 10 torr (˜1333 Pa).

Without being bound by theory, it is believed that halogen gas and hydrogen halide gas react with metals and metal oxides to form gas metal halides that diffuse out of the porous glass body 14. Similarly, it is believed that carbon monoxide reacts with metal oxides to form metal and carbon dioxide. For example, chlorine gas (Cl₂) and hydrogen chloride gas (HCl) react with metals and metal oxides to form gas metal chlorides. In the instance where the metal and metal oxide are iron (Fe) and ferric oxide (Fe₂O₃) respectively, the following reactions can occur:

Fe₂O₃+3CO⇒2Fe+3CO₂

Fe+2HCl=⇒FeCl₂+H₂

Fe₂O₃+6HCl=⇒2FeCl₃+3H₂O

Fe+3/2Cl₂=⇒FeCl₃

Fe₂O₃+3Cl₂=⇒2FeCl₃+3/2O₂

The reaction between the ferric oxide (Fe₂O₃) and carbon monoxide (CO) to generate iron (Fe) makes the reactions generating the ferrous chloride (FeCl₂) and ferric chloride (FeCl₃) more efficient. As mentioned, the ferrous chloride (FeCl₂) and ferric chloride (FeCl₃) are more easily diffusible out of the porous glass body 14 than iron (Fe) and ferric oxide (Fe₂O₃). Reacting with the halogen gas, such as to form a metal chloride (e.g., ferrous chloride (FeCl₂)) increases the likelihood of vaporization out of the porous glass body 14 because metal chlorides have lower boiling points or greater volatility than the elemental metal. For example, ferrous chloride (FeCl₂) has a boiling point of about 1023° C., while iron (Fe) has a boiling point of about 2860° C. Different halide gases and hydrogen halide gases react with other metals and metal oxides in similar ways to generate more easily diffusible gas metal halides.

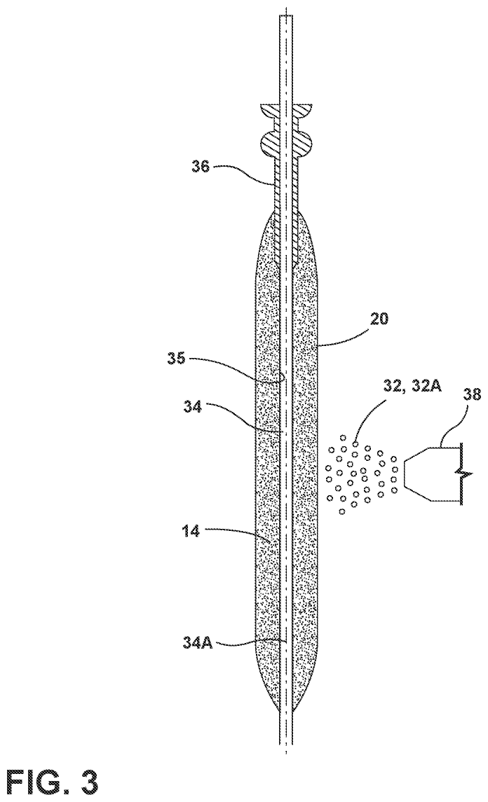

Referring particularly to FIG. 3, in embodiments, the method 10 further includes a core vapor deposition step 30. The core vapor deposition step 30 occurs before the first heat treatment step 12 and results in the formation of the porous glass body 14 that is treated in the first heat treatment step 12. The core vapor deposition step 30 includes vapor depositing core glass material 32 upon a substrate 34 to form the porous glass body 14 that includes the core glass material 32. Vapor deposition is the depositing of a thin film of material (here, the core glass material 32) onto a substrate 34 via a vapor phase. In general, source material for the material (e.g., core glass material 32) to be deposited is vaporized, such as through the application of heat. The vaporized material reacts to form reaction products (here, the core glass material 32) that are directed to the substrate 34 and form thereupon as a thin film of the material. In embodiments, the core glass material 32 is or comprises silicon dioxide (SiO₂).

For the core vapor deposition step 30, a variety of vapor deposition processes could be utilized. For example, a modified form of chemical vapor deposition (CVD) can be utilized. In this modified form of CVD, the substrate 34 with a centerline 34A is inserted through a hollow glass handle 36 and mounted on a lathe (not illustrated). The lathe rotates and translates the substrate 34 near a burner 38. The burner 38 produces a flame that heats the substrate 34. A gas mixture of source materials for the core glass material 32 is introduced into the flame. The flame causes the gas mixture of the source materials to react. The product or products of the reaction form on the substrate 34 as layers of the core glass material 32. The layers of the core glass material 32 accumulate until the desired size of the porous glass body 14 is achieved. This modified form of CVD is sometimes referred to as outside vapor deposition (OVD). The product or products of the reaction is sometimes referred to as “soot.” The substrate 34 may be referred to as “bait substrate” or “bait rod.” The reaction of the mixture of precursor gases within the flame is a flame hydrolysis or oxidation reaction.

In embodiments, the substrate 34 (e.g., the bait rod) is a metal, a metal alloy, or a ceramic. In embodiments, the substrate 34 includes aluminum oxide (e.g., Al₂O₃). In other embodiments, the substrate 34 includes high-purity silica glass. The high-purity silica glass can be porous.

In embodiments, the core glass material 32 includes SiO₂, and the source material for the SiO₂ in the core glass material 32 includes silicon tetrachloride (SiCl₄). In other embodiments, the source material for the SiO₂ in the core glass material 32 is or includes tetraethyl orthosilicate (TEOS), silane (SiH₄), or octamethylcyclotetrasiloxane ([CH₃)₂SiO]₄, also known as D₄). Other source materials for the SiO₂ in the core glass material 32 are possible, and this list is not intended to be exclusive.

In embodiments, the core glass material 32 includes a dopant, and the source material for the dopant in the core glass material 32 includes germanium tetrachloride (GeCl₄). In other embodiments, the source material for the dopant in the core glass material 32 is or includes germane (GcH₄), diborane (B₂H₆), phosphine (PH₃), titanium tetrachloride (TiCl₄), titanium tetraisopropoxide (Ti(OCH(CH₃)₂)₄), hydrogen fluoride (HF), tetrafluoromethane (CF₄), silicon tetrafluoride (SiF₄), aluminum chloride (AlCl₃), aluminum nitrate (Al(NO₃)₃), erbium chloride (ErCl₃), or erbium nitrate (Er(NO₃)₃). Other first source materials for the dopant are possible, and this list is not intended to be exclusive.

In some instances, the gas mixture for the core vapor deposition step 30 includes oxygen gas (O₂).

Because of the core vapor deposition step 30 in one embodiment, the porous glass body 14 that is vapor deposited onto the substrate 34 includes SiO₂ doped with a dopant such as GeO₂. In other instances, the dopant is or includes P₂O₅, SiF₄, B₂O₃, Al₂O₃, Er₂O₃, or TiO₂, depending on the source material for the doping constituent used in the core vapor deposition step 30. In short, during the core vapor deposition step 30, when the reaction products condense to the porous glass body 14, atoms of the dopant or oxides of the dopant (e.g., Ge atoms, GeO₂) take the place of silicon atoms or silica (SiO₂) in the silica network of the porous glass body 14. The incorporation of the dopant modifies one or more properties of the portion of an optical fiber derived from the porous glass body 14, such as the index of refraction.

When no other core glass material 32 is added, the porous glass body 14 formed via the core vapor deposition step 30 is the porous glass body 14 subjected to the first heat treatment step 12 discussed above.

In embodiments, the method 10 further includes a second core vapor deposition step 31. The second core vapor deposition step 31 includes vapor depositing second core glass material 32A over the core glass material 32 that was deposited during the core vapor deposition step 30 to further form the porous glass body 14. The second core vapor deposition step 31 occurs after the core vapor deposition step 30. The second core glass material 32A can be (or consist essentially of) silicon dioxide (SiO₂). The second core glass material 32A and the core glass material 32 are different.

Like the core vapor deposition step 30, in embodiments, the second core vapor deposition step 31 is an OVD process that utilizes the burner 38 that produces the flame. A second gas mixture of a second source material is introduced to the flame, and the second source material reacts. The product of the reaction is deposited as layers of the second core glass material 32A over the core glass material 32. The core vapor deposition step 30 and the second core vapor deposition step 31 collectively can be referred to as a “soot-on-soot” deposition process. In embodiments, as a consequence of the second core vapor deposition step 31, the porous glass body 14 is porous silicone dioxide (SiO₂) disposed over porous silicon dioxide doped with germanium dioxide (GeO₂).

In embodiments, the second source material is or includes silicon tetrachloride (SiCl₄). In other embodiments, the second source material is or includes tetraethyl orthosilicate (TEOS), silane (SiH₄), or octamethylcyclotetrasiloxane ([CH₃)₂SiO]₄, also known as D₄). Other second source materials are possible, and this list is not intended to be exclusive. In embodiments, no doping constituent is used in the second core vapor deposition step 31.

Without being bound by theory, it is believed that the core vapor deposition step 30 (and the second core vapor deposition step 31, if performed) may cause the formation of one or more metals or metal oxides within the porous glass body 14. The one or more metals or metal oxides may arise from impurities in the source materials, or as contaminants from the apparatus used for vapor deposition. As explained above, the one or more metals or metal oxides are undesirable because, it is theorized, the one or more metals or metal oxides increases the attenuation that the resulting optical fiber exhibits. The one or more metals or metal oxides that are theorized to be in the porous glass body 14 are difficult to quantify, because they may exist in the parts per billion range. The removal of the one or more metals or metal oxides, or alteration of the oxidation state of the one or more metals or metal oxides, in the first heat treatment step 12, decreases the attenuation of the optical fiber derived from the porous glass body 14.

In embodiments, the method 10 further comprises a substrate removal step 40. The substrate removal step 40 occurs after the core vapor deposition step 30 (and the second core vapor deposition step 31, if performed). The substrate removal step 40 includes removing the substrate 34 from the porous glass body 14. In embodiments, before the core vapor deposition step 30, a coating of a release agent is applied to the substrate 34. An example release agent is a carbonaceous material such as carbon soot. The carbon soot constitutes a sacrificial layer that prevents adhesion of the porous glass body 14 to the substrate 34. During formation of the porous glass body 14 the sacrificial carbon layer is progressively oxidized and vaporized to create a narrow gap between the substrate 34 and the porous glass body 14. The narrow gap facilitates removal of the substrate 34 from the porous glass body 14. Other release agents can be utilized.

In embodiments, the method 10 further includes a preheating heat treatment step 42. The preheating heat treatment step 42 occurs before the first heat treatment step 12. The preheating heat treatment step 42 can occur within the same furnace 16 in which the first heat treatment step 12 occurs. The preheating heat treatment step 42 includes activating the heating elements 18 of the furnace 16 so that the environment 26 to which the porous glass body 14 is subjected has a preheating temperature that is greater than or equal to 800° C. but below the first temperature. The porous glass body 14 is subjected to the environment 26 having the preheating temperature for a preheating period of time.

Exposing the porous glass body 14 to the preheating temperature also vaporizes metals and metal oxides within the porous glass body 14 and changes the oxidation state of the metals and metal oxides within the porous glass body 14. In embodiments, during the preheating heat treatment step 42, the environment 26 to which the porous glass body 14 is subjected includes a halogen gas, a hydrogen halide gas, or carbon monoxide. The discussion above regarding the introduction of a halogen gas, a hydrogen halide gas, or carbon monoxide (or some combination thereof) during the first heat treatment step 12 applies equally as well here. The presence of the halogen gas, the hydrogen halide gas, or carbon monoxide causes a reaction with the metals and metal oxides that produce metal halides with a relatively low boiling point. The metal halides generated can more easily diffuse out of the porous glass body 14 during the preheating heat treatment step 42 and the first heat treatment step 12 than the metal and metal oxide precursors.

In embodiments, the preheating temperature is within a range of from 800° C. to 1200° C. In embodiments, the preheating temperature is within a range of from 1050° C. to 1200° C. In embodiments, the preheating temperature is 800° C., 850° C., 900° C., 950° C., 1000° C., 1050° C., 1100° C., 1150° C., or 1200° C., or within any range bound by any two of those values (e.g., from 1050° C. to 1100° C., from 950° C. to 1150° C., and so on).

In embodiments, the preheating period of time is greater than or equal to 2 hours. In embodiments, the preheating period of time is within a range of from 2 hours to 6 hours. In embodiments, the preheating period of time is 2 hours, greater than 2 hours, 2.5 hours, 3 hours, 3.5 hours, 4 hours, 4.5 hours, 5 hours, 5.5 hours, or 6 hours, or within any range bound by any two of those values (e.g., from 2.5 hours to 3.5 hours, from 3 hours to 4 hours, and so on). Any of the preheating periods of time can be paired with any of the preheating temperatures.

Although the preheating heat treatment step 42 removes metals, metal oxides, and metal halides from the porous glass body 14 and changes the oxidation state of the metals and metal oxides, it was discovered that some metals and metal oxides were resistant to vaporization, change in oxidation state, and reaction with the cleaning gas 29. Thus, despite the preheating heat treatment step 42, metals and metal oxides were remaining in the porous glass body 14. Optical fiber subsequently drawn from the porous glass body 14 was exhibiting suboptimal attenuation.

The addition of the first heat treatment step 12, which is conducted at a higher temperature than the preheating heat treatment step 42, facilitates removal of the metals, metal oxides, and metal halides that stubbornly remained within the porous glass body 14 during the preheating heat treatment step 42. The first temperature being higher than the preheating temperature raises the temperature within the porous glass body 14 to a higher temperature. In the presence of a halogen gas like chlorine gas (Cl₂), the probability of metals and metal oxides such as iron (Fe) and ferric oxide (Fc₂O₃) reacting with the chlorine gas (Cl₂) increases with increasing temperature. The higher temperature and the longer time at the higher temperature that the first heat treatment step 12 affords compared to the preheating heat treatment step 42 alone results in greater removal of the metals and metal oxides from the porous glass body 14.

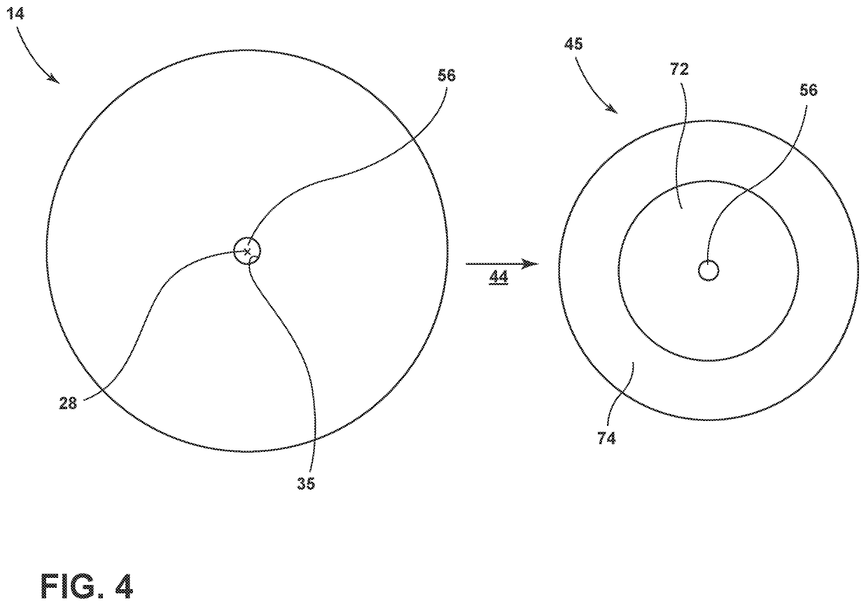

Referring to FIG. 4, in embodiments, the method 10 further includes a second heat treatment step 44 following the first heat treatment step 12. The second heat treatment step 44 includes activating the heating elements 18 of the furnace 16 so that the environment 26 to which the porous glass body 14 is subjected has a second temperature that is greater than or equal to 1400° C. As a result, the porous glass body 14 densifies. The second temperature is sufficient to cause appreciable physical changes within the porous glass body 14. The pores substantially narrow and close.

In embodiments, during the second heat treatment step 44, the porous glass body 14 densifies primary radially inward toward the centerline 28 of the porous glass body 14. Without having conducted the first heat treatment step 12, densifying the porous glass body 14 radially inward would likely cause the resulting optical fiber derived from the porous glass body 14 to exhibit suboptimal attenuation. That is because densifying the porous glass body 14 radially inward seals the surface 20 of the porous glass body 14 and prevents metals, metal oxides, and metal halides beneath the surface 20 from vaporizing and leaving the porous glass body 14. The presence of the metals, metal oxides, and metal halides causes the optical fiber to exhibit suboptimal attenuation. However, the first heat treatment step 12 removes those metals, metal oxides, and metal halides. The optical fiber subsequently produced exhibits better attenuation, despite the porous glass body 14 densifying radially inward during the second heat treatment step 44. In embodiments, the second heat treatment step 44 continues until the density at the surface 20 of the porous glass body 14 is greater than 99% of the closed pore density. The second heat treatment step 44 thus transforms the porous glass body 14 into a sintered glass preform 45. In embodiments where the second core vapor deposition step 31 was performed the sintered glass preform 45 includes a first core portion 72 (formed from the core vapor deposition step 30) and a second core portion 74 (formed from the second core vapor deposition step 31) surrounding the first core portion 72. Due to the removal of the substrate 34 at the substrate removal step 40, both the porous glass body 14 and the sintered glass preform 45 may further include an internal cavity 56 corresponding to the space formally occupied by the substrate 34.

In embodiments, the second temperature is within a range of from 1400° C. to 1600° C. In embodiments, the second temperature is within a range of from 1400° C. to 1500° C. In embodiments, the second temperature is 1400° C., 1425° C., 1450° C., 1475° C., 1500° C., 1525° C., 1550° C., 1575° C., or 1600° C., or within any range bound by any two of those values (e.g., 1425° C. to 1525° C., from 1450° C. to 1550° C., and so on).

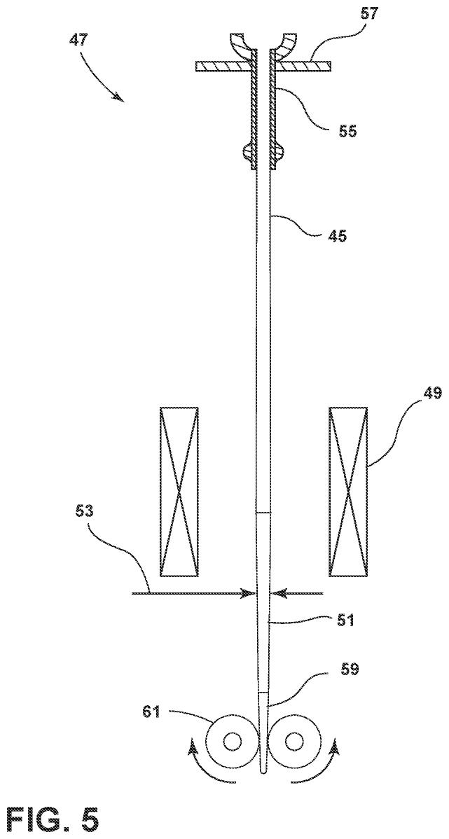

Referring additionally to FIG. 5, the method 10 further includes a redraw step 47. For the redraw step 47, the sintered glass preform 45 is heated in a redraw furnace 49 and drawn into a core cane 51 having a diameter 53 smaller than the original diameter of the sintered glass preform 45. More specifically, a glass handle 55 is attached to the sintered glass preform 45 and the sintered glass preform 45 is mounted in a moving downfeed support 57 above the redraw furnace 49. A sacrificial glass rod 59, which may be attached to the bottom of the sintered glass preform 45 is pulled by motor-driven tractors 61, thereby causing the core cane 51 to be drawn at a suitable rate. The diameter 53 of the core cane 51 resulting from the redraw step 47 is preferably in the range of from 15 mm to 35 mm, such as from 24 mm to 26 mm. During the redraw step 47 numerous core canes 51 are formed from the sintered glass preform 45, and the internal cavity 56 is collapsed, due to the decrease in the diameter 53. In other words, the internal cavity 56 present in the sintered glass preform 45 is not present in the core canes 51.

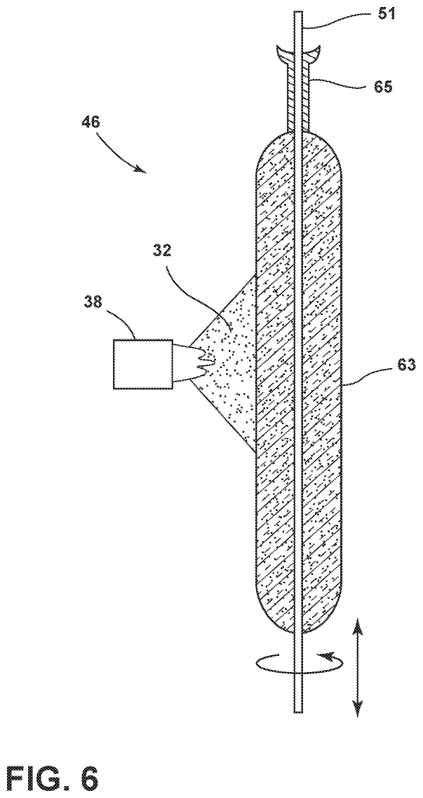

Referring additionally to FIG. 6, in embodiments, the method 10 further includes an outer cladding vapor deposition step 46. The outer cladding vapor deposition step 46 includes forming a porous outer cladding layer 63 over the core cane 51. The core cane 51 can be used as a bait substrate upon which the porous outer cladding layer 63 is deposited as overclad using a chemical vapor deposition method, such as that with the burner 38 as described above. A glass handle 65 is attached to the core cane 51, and the reaction products 32 (e.g., SiO₂) made from burning source material are formed upon the core cane 45. More than one porous outer cladding layer 63 can be applied over the core cane 51. The source material for the porous outer cladding layer 63 can be octamethylcyclotetrasiloxane, among other options.

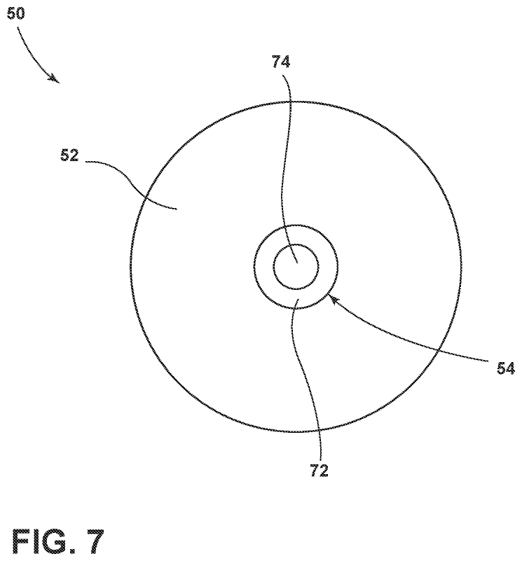

Referring additionally to FIG. 7, in embodiments, the method 10 further includes a cladding sintering step 48 of sintering the porous outer cladding layer 63. The sintering of the porous outer cladding layer 63 occurs at temperatures above about 1300° C. and induces compaction of the porous outer cladding layer 63 via collapse of the pore structure to provide again a fully densified glass body, this time referred to as an optical fiber preform 50. The optical fiber preform 50 includes a cladding portion 52 from the porous outer cladding layer 63 and a core portion 54 from the sintered glass preform 45 (via the porous glass body 14). In embodiments where the second core vapor deposition step 31 was performed, the core portion 54 includes the first core portion 72 and the second core portion 74.

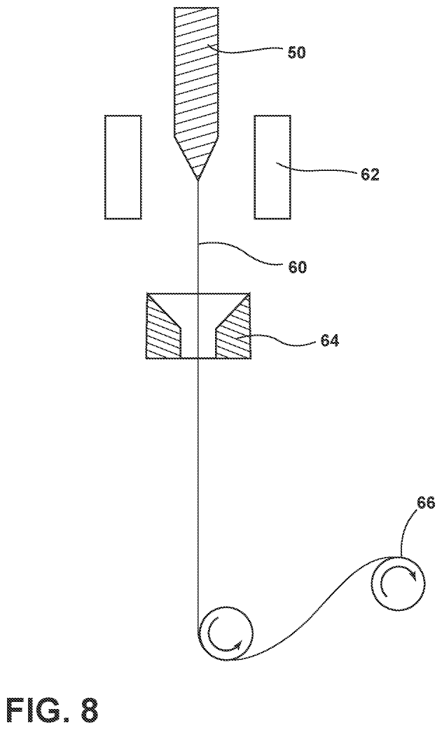

In embodiments, referring now to FIG. 8, the method 10 further comprises an optical fiber draw step 58. The optical fiber draw step 58 includes drawing optical fiber 60 from a preform (e.g., the optical fiber preform 50) made from the porous glass body 14. Note that there are ways to make a preform from which the optical fiber 60 can be drawn that do not include the steps of forming the porous cladding layer and sintering the porous cladding layer. For example, the porous glass body 14 can itself be a cladding layer in a cane-in-soot process. In any event, the drawing of optical fiber 60 from the optical fiber preform 50 can be accomplished by placing the optical fiber preform 50 in a drawing tower, heating the optical fiber preform 50 with heating elements 62 to soften the glass network, pulling a thin strand of glass as the optical fiber 60 from the softened optical fiber preform 50, coating the optical fiber 60 at a coater 64, and then spooling the optical fiber 60 on a spool 66.

Due considerably to the first heat treatment step 12, the optical fiber 60 exhibits acceptable levels of attenuation. In embodiments, the optical fiber 60 exhibits an attenuation of electromagnetic radiation having a wavelength of 1310 nm of less than or equal to 0.32 dB/km. In embodiments, the optical fiber 60 exhibits an attenuation of electromagnetic radiation having a wavelength of 1550 nm of less than or equal to 0.18 dB/km. In embodiments, the optical fiber 60 exhibits an attenuation of electromagnetic radiation having a wavelength of 1310 nm of less than or equal to 0.324 dB/km. In embodiments, the optical fiber 60 exhibits an attenuation of electromagnetic radiation having a wavelength of 1550 nm of less than or equal to 0.185 dB/km. Attenuation values are measured with an optical time-domain reflectometer in accordance with International Electrotechnical Commission (IEC) International Standard: IEC 60793-1-40 Method C.

The first heat treatment step 12 addresses the attenuation issue discussed above, because optical fiber 60 drawn from a porous glass body 14 subjected to the first heat treatment step 12 exhibits improved attenuation compared to optical fiber drawn from a porous glass body 14 not subjected to the first heat treatment step 12. As explained, the first temperature of the first heat treatment step 12 is high enough to facilitate effective removal of metals, metal oxides, and metal halides (if present) from the porous glass body 14, or change the oxidation state of the metals and metal oxides. The presence of the cleaning gas 29 further facilitates the removal of metals and metal oxides by reacting therewith to form metal halides, which have a lower boiling point and are thus more easily diffusible out of the porous glass body than metals and metal oxides.

In instances where the preheating heat treatment step 42 and the second heat treatment step 44 are both conducted, in addition to the first heat treatment step 12, the first heat treatment step 12 can be thought of as a “mid-temperature hold” that facilitates removal of the metals, metal oxides, and metal halides without simultaneously causing too much and too rapid densification of the porous glass body 14 that would be counterproductive to removal of the metals, metal oxides, and metal halides. The preheating step can remove some of the metals and metal oxides from the porous glass body 14 (and change oxidation states) but the higher temperature of the first temperature compared to the preheating temperature is more effective. Further, the higher temperature of the first temperature compared to the preheating temperature drives greater reaction between the metal and metal oxides with the cleaning gas 29.

The second heat treatment step 44 having a second temperature that is higher than the first temperature purposefully causes densification of the porous glass body 14 now that the first heat treatment step 12 sufficiently removed metals, metal oxides, and metal halides from the porous glass body 14. The attenuation that optical fiber 60 drawn from the optical fiber preform 50 derived from the porous glass body 14 subjected to the first heat treatment step 12 exhibits is improved compared to optical fiber drawn from an optical fiber preform derived from a porous glass body not subjected to the first heat treatment step 12.

The first heat treatment step 12 may be especially beneficial in situations where densification of the porous glass body 14 during the second heat treatments step occurs radially inward from the surface 20 of the porous glass body 14. In some instances, it may be possible to densify the porous glass body 14 in a furnace 16 where the porous glass body 14 is slowly driven through a narrow hot zone that locally heats the porous glass body 14 and causes densification at that local volume. In those instances, because the closing of pores is localized, metals, metal oxides, and metal halides within the porous glass body 14 still have a chance to vaporize and escape. However, such a localized heating process may not be possible for a variety of reasons, such as the length 22 of the porous glass body 14 compared to the size of the furnace 16, and thus densification occurs radially inward along the length 22 of the porous glass body 14. However, because the first heat treatment step 12 already removed the metals, metal oxides, and metal halides, the lack of pores through which vaporized metals, metal oxides, and metal halides can escape is not an issue. The first heat treatment step 12 thus allows for a wider range of furnaces and lengths 22 of the porous glass body 14 to be utilized.

### Examples

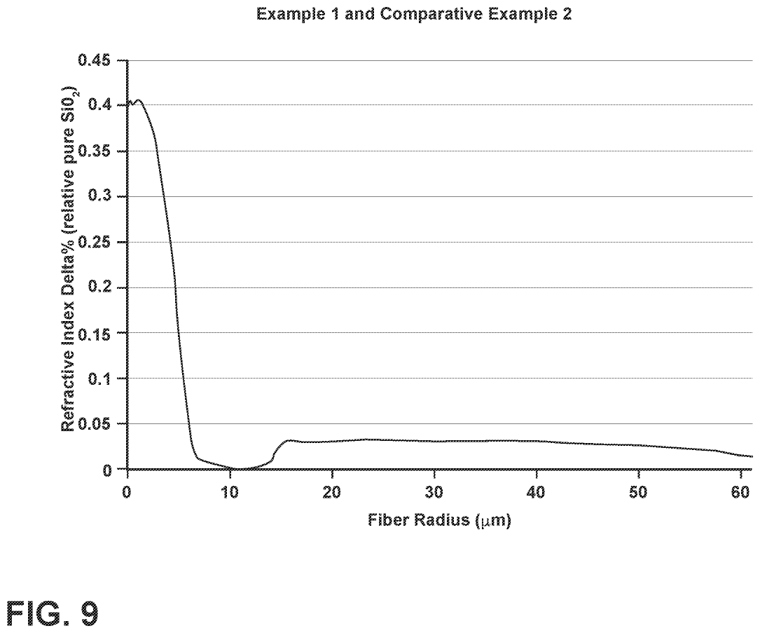

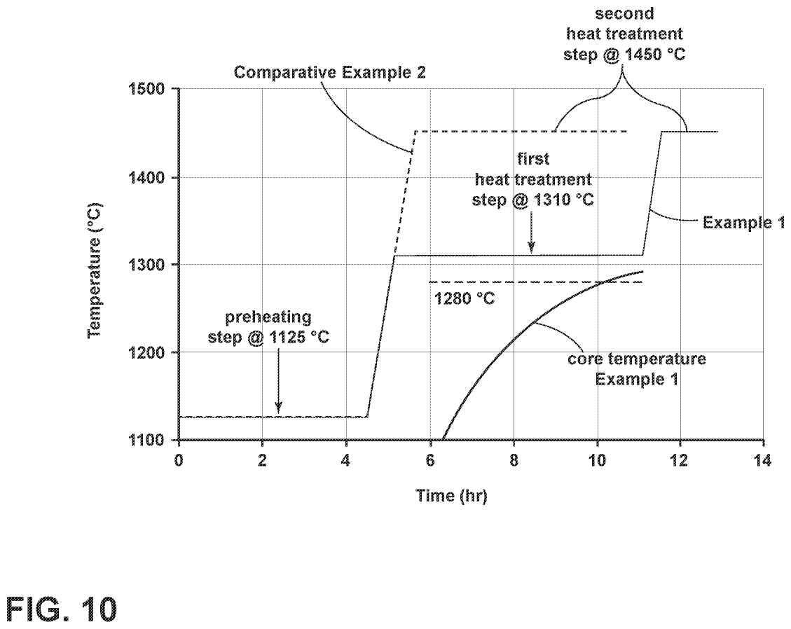

Example 1—Referring now to FIGS. 9-12, for Example 1, a porous glass body was formed. More particularly, a core vapor deposition step was conducted to form a porous glass body of SiO₂ as a glass former and GeO₂ as a doping constituent onto a substrate. The first source material for the glass former was SiCl₄. The first source material for the GeO₂ was GeCl₄. The flow rate of the GeCl₄ was controlled during the core vapor deposition step in order to produce a graded core profile in the optical fiber, with α-profile having, for example, α-value within a range of greater than 2 to 6, exhibiting a relative (to SiO₂) refractive index (Δ) of from 0% to 0.5%. The relative refractive index changes as a function of position from the centerline, as illustrated in FIG. 9, due to the managed flow rate of GeCl₄ during the core vapor deposition step. The wavelength for the relative refractive index values of FIG. 9 is 1550 nm.

The porous glass body was then subjected to a preheating heat treatment step in a furnace where the temperature of the environment within the furnace was 1125° C. The porous glass body was exposed to the 1125° C. environment within the furnace for 4.5 hours. For the preheating heat treatment step, chlorine gas (Cl₂) at 4 percent was caused to flow through the environment.

The porous glass body was then subjected to a first heat treatment step in the furnace where the temperature of the environment within the furnace was ramped up to, and maintained at, 1310° C. The porous glass body was exposed to the 1310° C. environment within the furnace for 6 hours. The temperature of the porous glass body near a centerline of the porous glass body was monitored. During the 6 hours, the temperature at the core rose and eventually reached 1280° C. The core spent more than an hour having a temperature greater than or equal to 1280° C. However, no significant densification occurred and pores within the porous glass body remained open to allow vaporized metals, metal oxides, and metal chlorides (formed during the preheating step) to escape. No cleaning gas was flowed through the environment during the first heat treatment step.

After the 6 hours at 1310° C., the heating elements within the furnace were set to achieve a second heat treatment temperature of 1450° C. At 1450° C., densification of the porous glass body occurred thus transforming the porous glass body into a sintered glass preform. The densification occurred radially inward from the surface toward the centerline.

The sintered glass preform was then subjected to a redraw step and core canes were produced therefrom. The core canes were subjected to an outer cladding vapor deposition step to deposit a porous outer cladding layer of SiO₂ (from octamethylcyclotetrasiloxane source material) over the core cane. The porous outer cladding layer over the core cane was then subjected to a cladding sintering step to sinter the porous outer cladding layer and form an optical fiber preform. Optical fiber was then drawn from the optical fiber preform.

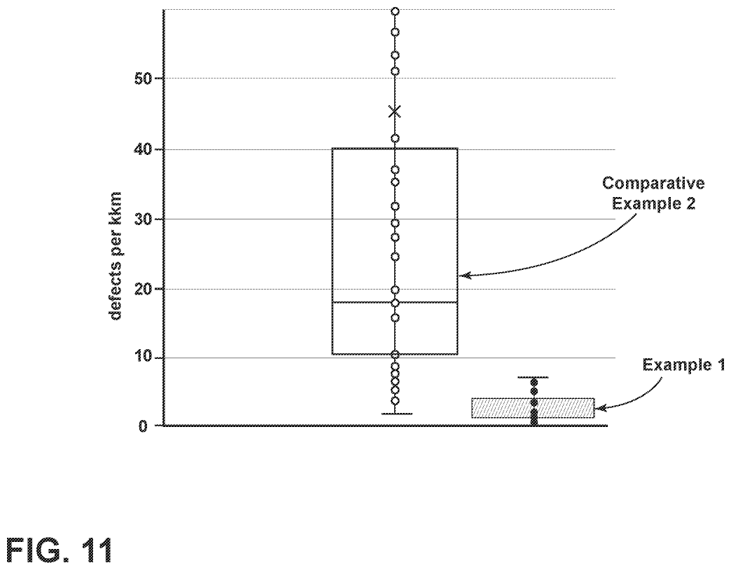

Samples of the optical fiber were tested to quantify (i) defect density of the optical fiber and (ii) attenuation that the optical fiber exhibits. As mentioned, defect density is the number of holes and diameter upsets within the optical fiber per unit length of the optical fiber (e.g., defects/kkm). The results for defect density are set forth in the graph reproduced at FIG. 11. As the graph reveals, there were about 1 to 3 defects per kkm of optical fiber generated from Example 1 using the first heat treatment step as described herein. A “kkm” is a kilokilometer, which is 1 million meters. Units of kkm are commonly used in the optical fiber art due to the ultralong distances that optical fibers traverse.

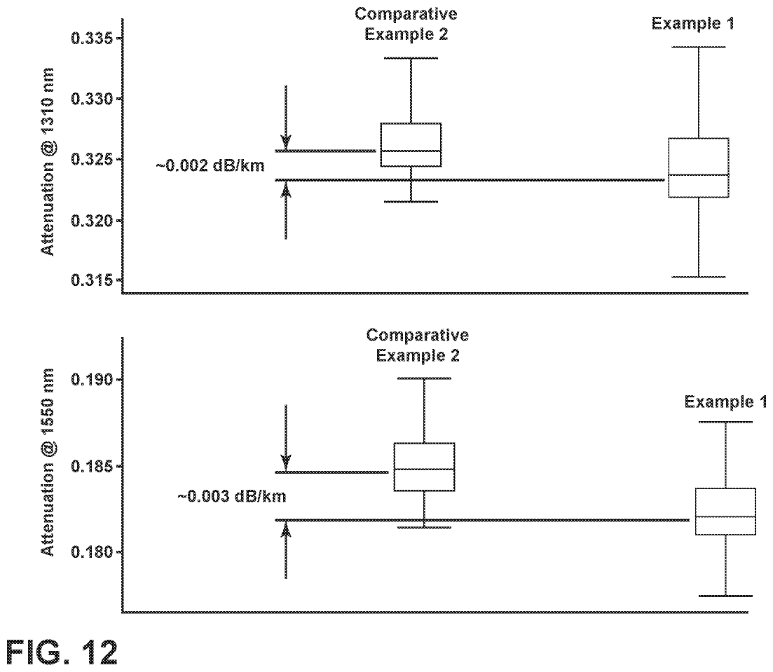

The results for attenuation at 1310 nm and 1550 nm, as measured with an optical time-domain reflectometer, are set forth at FIG. 12. The attenuation at 1310 nm was about 0.324 dB/km. The attenuation at 1550 nm was about 0.182 dB/km.

Comparative Example 2—For Comparative Example 2, everything was the same as described for Example 1 except that the first heat treatment step at 1310° C. was not performed. Rather, the porous glass body was subjected to the preheating step and then subjected directly to the second heat treatment step to densify the porous glass body. Samples of optical fiber were tested for defect density and attenuation. As the graph of FIG. 11 reveals, there were about 10 to 40 defects per kkm for optical fibers of Comparative Example 2. In addition, as the graph of FIG. 12 reveals, the attenuation at 1310 nm was about 0.326 dB/km and the attenuation at 1550 nm was about 0.185 dB/km.

Upon comparing the defect density of the optical fiber made in Example 1 (using the first heat treatment step) with the optical fiber made in Comparative Example 2 (not using the first heat treatment step), it is clear that the optical fiber made in Example 1 had much less defect density than the optical fiber made in Comparative Example 2. Thus, in addition to removing metals, metal oxides, and metal halides from the porous glass body, the first heat treatment step as described removes contamination, inclusions, and other defects in the porous glass body that would have translated into defects in the optical fiber.

A similar comparison for attenuation reveals that optical fiber from Example 1 (using the first heat treatment step) exhibited about 0.002 dB/km less attenuation of electromagnetic radiation having a wavelength of 1310 nm than optical fiber from Comparative Example 2 (not using the first heat treatment step). Similarly, optical fiber from Example 1 (using the first heat treatment step) exhibited about 0.003 dB/km less attenuation of electromagnetic radiation having a wavelength of 1550 nm than optical fiber from Comparative Example 2 (not using the first heat treatment step). The improvements of 0.002 dB/km and 0.003 dB/km for Example 1 compared to Comparative Example 2 are significant.

What is claimed is:

1. A method of manufacturing comprising:
with a porous glass body having a surface and a density at the surface having been loaded into a furnace with heating elements, a first heat treatment step comprising activating the heating elements until the porous glass body at an inner surface of the porous glass body facing a centerline of the porous glass body has a first temperature that is greater than or equal to 1250° C. for a first period of time greater than or equal to 1 hour;
wherein, as a result of the first heat treatment step, the density of the porous glass body at the surface increases but is less than 85% of a closed pore density of a sintered glass preform made from the porous glass body.

2. The method of claim 1, wherein
a length of the porous glass body, before the first heat treatment step occurs, is greater than or equal to 1 meter.

3. The method of claim 1, wherein
the first temperature is within a range of from 1250° C. to 1400° C.

4. The method of claim 1, wherein
the first temperature is within a range of from 1250° C. to 1350° C.

5. The method of claim 1, wherein
the first period of time is greater than or equal to 4 hours.

6. The method of claim 1, wherein
the first period of time is within a range of from 4 hours to 9 hours.

7. The method of claim 1, wherein
during the first heat treatment step, an environment to which the porous glass body is subjected within the furnace comprises a cleaning gas comprising a halogen gas, a hydrogen halide gas, or carbon monoxide.

8. The method of claim 1, further comprising:
a core vapor deposition step of vapor depositing core glass material upon a substrate to form the porous glass body.

9. The method of claim 1, further comprising:
a preheating heat treatment step, occurring before the first heat treatment step, comprising activating the heating elements of the furnace so that the environment to which the porous glass body is subjected has a preheating temperature that is greater than or equal to 800° C. but below the first temperature for a preheating period of time.

10. The method of claim 9, wherein
during the preheating step, the environment to which the porous glass body is subjected comprises a halogen gas, a hydrogen halide gas, or carbon monoxide.

11. The method of claim 9, wherein
the preheating temperature is within a range of from 800° C. to 1200° C.

12. The method of claim 9, wherein
the preheating period of time is greater than or equal to 2 hours.

13. The method of claim 1, further comprising:
a second heat treatment step comprising activating the heating elements of the furnace so that the environment to which the porous glass body is subjected has a second temperature that is greater than or equal to 1400° C. thus causing the porous glass body to densify.

14. The method of claim 13, wherein
during the second heat treatment step, the porous glass body densifies primarily radially inward toward a centerline of the porous glass body.

15. The method of claim 13, wherein
the second temperature is within a range of from 1400° C. to 1600° C.

16. The method of claim 13, wherein
the second heat treatment step occurs until the density at the surface of the porous glass body is greater than 99% of the closed pore density, thus transforming the porous glass body into a sintered glass preform.

17. The method of claim 16, further comprising:
a redraw step comprising redrawing the sintered glass preform into a core cane.

18. The method of claim 17, further comprising:
an outer cladding vapor deposition step comprising forming a porous outer cladding layer over the core cane; and
a cladding sintering step comprising sintering the porous outer cladding layer thus forming an optical fiber preform.

19. The method of claim 18, further comprising:
an optical fiber draw step comprising drawing an optical fiber from the optical fiber preform.

20. The method of claim 19, wherein
the optical fiber exhibits an attenuation of electromagnetic radiation having a wavelength of 1310 nm of less than or equal to 0.324 dB/km as measured with an optical time-domain reflectometer, and
the optical fiber exhibits an attenuation of electromagnetic radiation having a wavelength of 1550 nm of less than or equal 0.186 dB/km as measured with an optical time-domain reflectometer.
